(19) United States
(12) Patent Application Publication
(10) Pub. No.: US 2025/0166067 A1
(43) Pub. Date: May 22, 2025

(54) CARBON EMISSIONS TRACKING AND TRADING USING BLOCKCHAIN

(71) Applicant: American University of Sharjah, Sharjah (AE)

(72) Inventors: Alia Al-Sadawi, Sharjah (AE); Malick Ndiaye, Sharjah (AE)

(21) Appl. No.: 18/953,697

(22) Filed: Nov. 20, 2024

Related U.S. Application Data
(60) Provisional application No. 63/602,222, filed on Nov. 22, 2023.

(51) Int. Cl. G06Q 40/04; G06Q 20/38

(52) U.S. Cl. CPC G06Q 40/04; G06Q 20/38215

(57) ABSTRACT

Climate change poses a significant threat to human well-being, the planet's sustainability, and the global economy, mainly caused by excessive greenhouse gas emissions, particularly CO2. To combat this phenomenon, various tools have been adopted, with the most effective being the carbon emission trading scheme established by the United Nations which created a system that monetizes and reduces CO2 emissions. However, the current system faces multiple challenges, such as manipulation, complexity, and a lack of integrity, preventing it from achieving its ultimate objectives. To tackle these issues, blockchain technology has been proposed due to its distinguishing characteristics of security, traceability, decentralization, and trust. However, blockchain frameworks existing in the literature have been inefficient and inadequate. This research aims to design and develop a practical blockchain system that employs smart contracts and Internet of Things (IoTs) with the use of oracles to solve the problems facing the present carbon emission trading scheme and elevate its operations. The developed smart contracts automate the participating entities' registration and suspension processes and emitters released CO2 measurements as well as carbon credit assignment and trading operations. Our smart contracts were simulated, tested and analyzed where results proved the efficiency, integrity, traceability and security of all processes under the carbon trading market at a reduced cost.

### BACKGROUND

Carbon cap and trade systems are crucial in the global fight against climate change. These systems provide a market-based approach to reducing greenhouse gas emissions by setting a limit, or cap, on the total amount of emissions allowed by a particular industry or country. By creating a scarcity of emissions allowances or credits, carbon cap and trade systems encourage businesses to find innovative ways to reduce their carbon footprint.

One of the key requirements of carbon credit systems is that they must have the ability to effectively track carbon emissions. By requiring companies to measure and report their emissions, these systems provide a transparent and standardized way to quantify carbon outputs. This data is essential for policymakers, businesses, and investors to understand the scale of the problem and make informed decisions regarding emission reduction strategies, as well as compliance with carbon caps.

Carbon credit systems allow for flexibility in achieving emission reductions. Instead of imposing uniform regulations on all industries, these systems allow companies to buy and sell emission allowances or credits. This means that businesses with higher emissions can purchase credits from those with lower emissions, creating an economic incentive for more efficient and cleaner operations. This flexibility encourages innovation and fosters the development of new technologies and practices that can lead to significant emission reductions.

To accomplish these objectives, international organizations can implement carbon cap and trade systems to drive international cooperation in reducing carbon emissions. By establishing a global market for emissions credits, countries or organizations within those countries can collaborate and trade credits to meet specific reduction targets. This can help address the issue of carbon leakage, a phenomenon in which emissions-intensive industries move to countries with less stringent regulations, as these industries would still need to purchase credits regardless of their location. This global approach promotes fairness and encourages countries to work together towards a common goal of reducing carbon emissions.

Accordingly, improvements are needed that address these problems.

### SUMMARY

According to a first aspect, a platform uses smart contracts to automate the trading of carbon credits. It includes modules for agreements, suspension, registration, trading, and measurement. The agreements module assigns credits to emitters, the suspension module can suspend emitters, the registration module registers emitters, the trading module facilitates the buying and selling of credits, and the measurement module records carbon emissions. The measurement module uses sensors to automatically report carbon generation, and this data is stored on a secure ledger.

The platform's modules can create smart contracts that generate transaction blocks on the secure ledger. The administrator can assign credits to green projects, and the suspension and registration modules can handle these projects as well. The trading module can allow for the trading of carbon credits, and the registration module can register emitters. Meters at the emitters can provide carbon emission measurement data to the measurement module. A blockchain oracle can be used to communicate with the meters and measurement module. The agreements module can also be connected to web3 storage to receive document hashes.

According to another aspect, a set of smart contracts in a blockchain-based carbon trading system automates stakeholder registration, agreement and report management, carbon credit issuance and trading, suspension enforcement, and carbon output measurement. It includes contracts for registration, agreements, trading, suspension, and measurement. These contracts handle the registration of entities, the authorization and assignment of carbon credits, the buying and selling of credits, the suspension of entities, and the measurement and recording of carbon generation.

Optionally, the registration module can also handle registration fees from emission-reduction projects and map these projects to their identifiers. The agreements module can authorize and assign credits to emission-reduction projects, and the suspension module can suspend these projects if necessary. The measurement module can receive encrypted measurement data from the measurement devices, and a blockchain oracle can be used to communicate with the devices and measurement module. The agreements module can also receive a hash from web3 storage.

According to another embodiment, a method automates use of carbon credits using a blockchain-based platform. The method involves assigning credits to emitters, registering emitters, generating trading transactions for buying and selling credits, and generating measurement transactions based on actual carbon output. The platform also includes a suspension module to suspend emitters if needed.

The method can also include creating suspension transactions to suspend emitters, assigning credits to green projects, and including transactions for the trading and measurement of credits from these projects.

### BRIEF DESCRIPTION OF THE DRAWINGS

Aspects and advantages of the embodiments provided herein are described with reference to the following detailed description in conjunction with the accompanying drawings. Throughout the drawings, reference numbers may be re-used to indicate correspondence between referenced elements. The drawings are provided to illustrate example embodiments described herein and are not intended to limit the scope of the disclosure.

FIG. 1 is a simplified schematic of a carbon credit trading system.

FIG. 2 is a schematic of a system incorporating a blockchain network for managing carbon credit trading for a plurality of emitters and green projects.

FIG. 3 is a flowchart showing a registration smart contract implementation.

FIG. 4 is a flowchart showing a trading smart contract implementation.

FIG. 5 is a schematic depiction of a measurement device and an oracle used in a measurement smart contract.

FIG. 6 depicts an example of a suitable operating environment in which one or more of the present examples can be implemented.

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION

Reference will now be made in detail to exemplary aspects of the present disclosure that are illustrated in the accompanying drawings. Wherever possible, the same reference numbers will be used throughout the drawings to refer to the same or like parts.

Carbon credit trading systems are important tools in the fight against climate change. They enable effective tracking of carbon emissions, provide flexibility in achieving reductions, and promote international cooperation. By harnessing the power of markets and incentivizing emission reductions, these systems play a vital role in transitioning to a low-carbon economy and mitigating the impacts of climate change. As used throughout this application, the terms “credit,” “allowance,” or “permissions” may be used somewhat interchangeably. Although they have nuanced differences in the field of carbon emissions reduction, with respect to the technology described herein they are interchangeable. That is, a blockchain transaction may be used to record a transaction of a permission in much the same way as an allowance or a credit. Because “credit” is the most generic term, accounting for both allowances and permissions (e.g., carbon offsets, governmental permission for emissions up to some cap, or carbon reductions by other emitters, etc.) that term will be used primarily throughout this disclosure.

An accurate and reliable tracking system is needed for the success of carbon credit systems. When the tracking system for measuring or trading carbon credits is inaccurate or susceptible to cheating, it undermines the integrity of the entire system. Inaccurate measurements or fraudulent reporting can lead to an overallocation of emissions credits, allowing companies to emit more than their fair share of greenhouse gases. To address this challenge, conventional carbon trading systems may use costly monitoring and verification mechanisms, such as independent audits and satellite technology, to ensure the accuracy and credibility of reported emissions. Furthermore, audits may be needed to confirm that carbon credits are sold only once, or in conformance with rules regarding their sale or transfer. Only with a reliable tracking and trading system can carbon cap and trade systems effectively drive emission reductions and contribute to the global effort to combat climate change.

Implementing the carbon trading system using blockchain technology offers significant advantages over conventional methods of tracking carbon emissions and credits. First, blockchain provides an immutable and transparent ledger for recording all transactions related to carbon allowances, emissions, and credits. This transparency ensures that all stakeholders, including emitters, green projects, administrators, and independent verifiers, have access to a single source of truth, reducing the chances of discrepancies and fraud. Each transaction, whether it is the assignment of carbon credits, the trading of credits, or the verification of emission reductions, is securely recorded in a cryptographically verifiable ledger. This level of security and transparency builds trust among participants and ensures that the system operates with integrity and accountability.

Furthermore, blockchain technology automates many of the processes involved in the carbon trading system through the use of smart contracts. These self-executing contracts streamline the registration of emitters and projects, the issuance and trading of carbon credits, and the suspension of non-compliant entities. Unlike conventional contracts, smart contracts are a technological solution capable of automating and verifying in real-time items that could not feasibly be performed in the past. Automation reduces the administrative burden and minimizes human error, leading to greater efficiency and faster processing times. Additionally, the integration of real-time carbon measurement devices with the blockchain ensures that carbon emissions are accurately reported and recorded, enabling precise tracking and verification. This dynamic and automated approach not only enhances the reliability of the carbon trading system but also facilitates scalability, allowing more participants and transactions to be handled smoothly as the market grows.

### Climate Change and Carbon Tracking

Climate change is a critical global issue that affects all aspects of life, often irreversibly. As climate change worsens, every sector of society pays a price. It is a major concern not only for sustainability experts but also for economists. The drastic rise in Earth's temperature leads to higher sea levels, loss of biodiversity, and population displacement, among other issues. Specialists emphasize that climate change will have a more significant long-term impact on supply chains than the short-term disruptions caused by COVID-19. Economic losses are anticipated due to the scarcity and increased prices of raw materials, rising energy costs, and disruptions in goods transportation. Furthermore, climate change may prevent employees from reaching their workplaces, particularly in industries requiring physical presence, such as manufacturing. According to a United Nations Development Program report, workplace disruptions due to climate change could result in productivity losses exceeding $2 trillion by 2030. Therefore, it is undeniable that climate change is the greatest threat to our environment, economy, and overall existence.

Climate change results from the excessive emission of greenhouse gases (GHGs), particularly carbon dioxide (CO2). Governments worldwide recognize the severity of climate change and have implemented various tools to combat it, with carbon credits trading (CCT) being the most proven. CCT is a monetizing and trading scheme proposed by the United Nations as a solution to climate change. Emerging from the Kyoto Protocol, CCT is based on the “cap and trade” concept, where entities are allocated a certain amount of CO2 credits that they can trade to maintain targeted caps. Over time, the total cap is reduced to encourage sustainable operations that release fewer harmful emissions, thus promoting sustainability and preventing climate change and its consequences. Carbon emission trading is the primary practical measure implemented globally to address climate change. The European Union Emission Trading Scheme (EU-ETS) is the world's largest carbon trading scheme. It involves numerous participants and stakeholders and generates extensive records of transactions, including registered emitters, allocated credits, and traded quantities.

Governments around the world recognize the severity of climate change and the catastrophic consequences of inaction. Therefore, there have been coordinated global efforts to limit carbon dioxide and other greenhouse gas emissions. One of the most effective tools for achieving this goal is financial instruments such as carbon taxes, carbon emissions trading systems, carbon credits/offsets, and green markets. Among these, the carbon trading market (CTM) has proven to be the most effective. This market-based mechanism was proposed by the United Nations and is reflected in the Kyoto Protocol and the Paris Agreement. Both agreements view carbon trading as a primary means to achieve net-zero emissions and limit global temperature increases to 1.5 degrees Celsius.

The Paris Agreement lays the groundwork for producing carbon offset certificates, which can be traded in voluntary or regulated marketplaces. To participate in the carbon credits trading (CCT) scheme, each country must set a nationally determined contribution (NDC) target for reducing greenhouse gas emissions. Within this framework, entities in one country can reduce emissions locally and earn credits, which can then be sold to companies in other countries. These companies can use the credits to meet their net-zero goals or fulfill their emission reduction commitments.

Article 6 of the Paris Agreement facilitates these cooperative approaches by allowing countries to work together to achieve their NDCs. Article 6.2, for instance, enables countries to exchange carbon removals and reductions through bilateral or multilateral cooperative agreements. These tradable credits, known as internationally transferred mitigation outcomes (ITMOs), can be measured in carbon dioxide equivalents (CO2e) or other metrics like kilowatt-hours (kWh) of renewable energy. ITMOs can be used to fulfill NDCs or other international mitigation purposes, with some countries already having robust structures in place to purchase and apply them to their NDCs.

Beyond emissions reductions, climate mitigation projects under Article 6.2 can provide various development benefits such as job creation, technology transfer, support for livelihoods and food security, and gender empowerment. Examples of green projects include solar thermal power, offshore wind, green hydrogen, compressed biogas, emerging mobility solutions like fuel cells, tidal energy, and ocean thermal energy. Each project must be authorized by an appropriate body in the hosting country, verified by an independent verifier, and registered by an administrator before credits can be issued.

Participation in Article 6.2 requires countries to be a Party to the Paris Agreement, have an NDC, provide a recent national emission inventory report, and contribute to the long-term goals of the Paris Agreement. Procedures for authorizing and tracking the application of ITMOs must be in place to ensure compliance with NDC fulfillment. Article 6 also emphasizes preventing double counting of carbon credits through “corresponding adjustments,” where the selling nation subtracts the credits from its greenhouse gas inventory, allowing the purchasing nation to use them for its climate targets. Additionally, carbon credits or ITMOs have expiration dates, requiring them to be used within the NDC period in which they are issued.

The CCT mechanism encounters several significant challenges and shortcomings. One major issue is the lack of transparency in operations and data. The CCT system does not have a mechanism to monitor participants' registration, credits issuance, buying, and trading processes, nor does it publish verified and trusted information about these activities. This lack of transparency and monitoring undermines the credibility of the system.

Another challenge is the absence of a robust project credibility system. Although the authorization, verification, and registration of green projects are mandatory stages as per the Paris Agreement, there is no secure and trusted system to track these stages. This jeopardizes the credibility of green projects joining the CCT system and, by extension, the system itself.

The existing CCT platforms are centralized, posing serious issues related to system bottlenecks and single points of failure. Additionally, the process of issuing carbon credits is complex and conducted through a central authority, leading to multiple inefficiencies associated with centralization. There is also a lack of tracking mechanisms for measuring emissions, which reduces trust in the emitters' reports about their carbon emissions.

The CCT market suffers from fragmentation and the absence of a unified trading platform, resulting in carbon credits being traded on various platforms and often at different prices. The market is also dominated by third parties and brokers, which increases operational time and costs and raises the possibility of errors. Moreover, existing CCT systems are vulnerable to credit loss and double counting due to unsecured data records used for tracking carbon credits issuance and transfers.

Finally, the CCT mechanism is plagued by process complications. It involves various interdependent steps and processes that require a high level of accuracy and efficiency. The inefficient flow of operations increases the workload needed to verify system processes, which can hinder the practical implementation of the CCT mechanism.

As discussed in more detail below, blockchain technology addresses the core challenges of the current CCT mechanism by enhancing transparency, credibility, decentralization, security, and efficiency. Its ability to create a unified, trusted, and automated system makes it a powerful solution for the future of carbon credits trading.

### Blockchain Technology and Smart Contracts

Blockchain is a revolutionary technology based on a decentralized network structure comprising a chain of blocks that are time-stamped and linked using cryptographic hashes. This structure ensures that once information is recorded in a block, it cannot be altered retroactively without altering all subsequent blocks, which provides a high level of security and integrity. The value of blockchain emerges from its ability to establish consensus on valuable information that can be stored as transactions in these blocks. This exchange of information does not necessarily have to involve monetary transactions; it might also include property rights, music or video files, stocks, or any other kind of digital asset. Managed by a software protocol, blockchain permits safe online transfers of assets, money, and information without the need for intermediaries such as governments, financial institutions, lawyers, or brokers. By eliminating these middle parties, blockchain opens the door for a range of potential roles, the most important being its function as a marketplace. In a thriving ecosystem, a market is essential for generating value. Blockchain facilitates the creation of peer-to-peer marketplaces where buyers and sellers can connect directly, bypassing the need for intermediaries and their associated charges.

For blockchain technology to be useful, its components-such as assets, trust, ownership, money, identification, and contracts-must be programmable to enable the creation of new services. This is where smart contracts come into play. Smart contracts are fully programmable applications that reside and execute automatically on a blockchain when pre-set conditions are met, without any human intervention. These contracts can automate various operations, ensuring that transactions are carried out precisely as programmed. Additionally, blockchain technology's power and effectiveness are amplified when integrated with other advanced technologies, such as the Internet of Things (IoT). The IoT paradigm often suffers from problems related to its centralized structure and unauthenticated input sensor readings. Blockchain can address these issues by verifying data from sensors and adding the results to a distributed shared ledger, thereby elevating trust in IoT networks.

By using smart contracts, blockchain and IoT can be integrated to create autonomous systems that support a wide range of applications. Thus, the combination of blockchain and smart contracts not only enhances security and trust but also enables the automation of complex processes, paving the way for innovative and efficient solutions across various industries.

The inventors have recognized that blockchain provides an information storage and transmission technology that is transparent, secure, and operates without a central control body. It is characterized by fair information sharing which provides authenticity and credibility. This technology can track carbon emissions and CCT transactions, which prevents double counting and facilitates a strong transparent CCT mechanism. Blockchain technology offers a comprehensive technical solution to the numerous challenges and shortcomings inherent in the CCT mechanism. By leveraging the decentralized and transparent nature of blockchain, many of the issues related to transparency, credibility, centralization, and security can be effectively addressed.

Blockchain technology can significantly enhance transparency in CCT operations and data management. Each transaction, from the registration of participants to the issuance, buying, and trading of carbon credits, can be recorded on a public ledger. This ledger is accessible to all stakeholders, ensuring that information is transparent and verifiable. The consensus mechanism inherent in blockchain ensures that data is authenticated and tamper-proof, thus preventing manipulation and fostering trust among participants.

Blockchain can also address the lack of a robust project credibility system. The stages of authorization, verification, and registration of green projects can be programmed into smart contracts. These smart contracts automatically execute predefined conditions, ensuring that each project meets the necessary criteria before being registered in the CCT system. This automated and transparent process enhances the credibility of green projects and the overall system.

The decentralized nature of blockchain eliminates the issues related to centralization, such as system bottlenecks and single points of failure. By distributing the ledger across multiple nodes, blockchain ensures that the system remains resilient and operational even if some nodes fail. This decentralization also reduces the inefficiencies associated with a central authority managing the issuance of carbon credits, as the process can be automated through smart contracts.

Blockchain's capability to track emissions accurately addresses the challenge of verifying emitters' reports on their carbon emissions. By integrating blockchain with IoT devices, real-time data on emissions can be recorded and verified on the blockchain. This ensures that emission reports are accurate and trustworthy, enhancing the overall integrity of the CCT mechanism.

The fragmentation of the CCT market and the absence of a unified trading platform can be resolved by blockchain's ability to create a single, transparent marketplace. All transactions and trades can be recorded on a unified ledger, ensuring consistency in pricing and availability of carbon credits. This unified platform reduces operational costs and time associated with third parties and brokers, as transactions can be conducted directly between participants.

Moreover, blockchain's security features prevent credit loss and double counting. Each carbon credit transaction is recorded on the blockchain, creating an immutable audit trail. This ensures that credits are not duplicated and that the transfer history is clear and verifiable.

Blockchain also simplifies the complex processes involved in the CCT mechanism. By automating various steps through smart contracts, blockchain reduces the workload and potential for errors. This efficient flow of operations facilitates the practical implementation of the CCT mechanism, making it more robust and reliable.

Automation is greatly improved through the use of smart contracts, which enable the automatic execution of carbon trading and offsetting operations when predefined conditions are met. This reduces the need for human intervention, enhances system integrity, and ensures that each participant can only perform their authorized roles. Furthermore, blockchain's design prevents double-spending and theft, thereby eliminating fraudulent transactions of carbon credits or currency.

The inventors have developed a solution to address the various issues plaguing conventional carbon trading systems by leveraging the capabilities of blockchain technology. One of the primary advantages of this invention is the elimination of central servers and third-party intermediaries, thus resolving the single-point failure problem inherent in traditional systems. By removing these central points of control, the system becomes more resilient and less susceptible to corruption and failure. Additionally, blockchain's consensus mechanism ensures data authentication, thereby elevating the integrity of the carbon trading system and preventing data manipulation. This decentralized approach means that no single entity can control or corrupt critical data such as credit allocation, trading activities, or pricing information.

The system also provides lower transaction costs by eliminating intermediaries such as brokers, a common feature in the conventional CCT market. This reduction in costs can motivate more emitters to join the scheme. Additionally, the blockchain system facilitates faster trading processes, allowing for quicker transfer of credits and payments, thus reducing process time. The reliability and robustness of the system are guaranteed by the inherent values of blockchain technology, which has demonstrated high robustness across various fields. These comprehensive advantages make the inventors' solution a transformative improvement over traditional carbon trading systems, fostering a more secure, transparent, and efficient market for carbon emissions trading.

The blockchain systems described herein provide technical advantages over conventional systems, including the elimination of the need for central servers and third parties, enhanced trust, and improved security against falsified data authentications.

Blockchain technology provides a comprehensive solution to the challenges faced by the CCT mechanism and significantly enhances its operations. One of the primary benefits is the elimination of central servers and third parties, which resolves the single-point failure problem. Data authentication is achieved through blockchain's consensus mechanism, elevating the system's integrity and preventing manipulation. Consequently, no single corruptible entity controls data related to credit issuance, buying, trading, or pricing.

Trust within the CCT system is significantly enhanced by blockchain's distributed consensus algorithm, which ensures that all information remains tamper-proof. Participants can independently verify system data, fostering confidence and reliability in the scheme. Additionally, blockchain cryptography guarantees the security of CCT data, and its distributed nature prevents falsified data authentications. This means that no malicious entity can modify audits, transaction logs, or the terms encoded in smart contracts.

Privacy is another critical advantage provided by blockchain. The technology generates a unique and unbreakable private/public key pair for each participant, enabling the secure sharing of information with selected network entities only. Furthermore, blockchain chronologically stores information about emission measurements, prices, and trading in a ledger. This enables thorough system evaluation and tracing of trading actions over time, including credit movements and associated payments.

Transparency is greatly improved, as blockchain supports the visibility of CCT processes based on developed smart contracts. Designated entities can easily determine how and where carbon credits have been transferred, enhancing accountability. Smart contracts also enable the automation of carbon trading and offsetting operations. When a CCT system process meets pre-specified rules, the smart contract executes automatically, transferring cryptocurrency in exchange for traded carbon credits without human intervention. This automation enhances system integrity and ensures that each participant can perform only their authorized roles.

The design of blockchain prevents double-spending and theft, eliminating fraudulent transactions involving carbon credits or currency. By removing intermediaries such as brokers, blockchain significantly reduces transaction costs, motivating more emitters to join the scheme. Additionally, blockchain facilitates fast trading, allowing for quicker transfer of credits and payments, thereby reducing process time.

The inherent values of blockchain guarantee reliability and robustness in the CCT system. The successful application of blockchain in diverse fields further demonstrates its high robustness, making it a powerful and efficient solution for improving the carbon credits trading mechanism.

### Examples

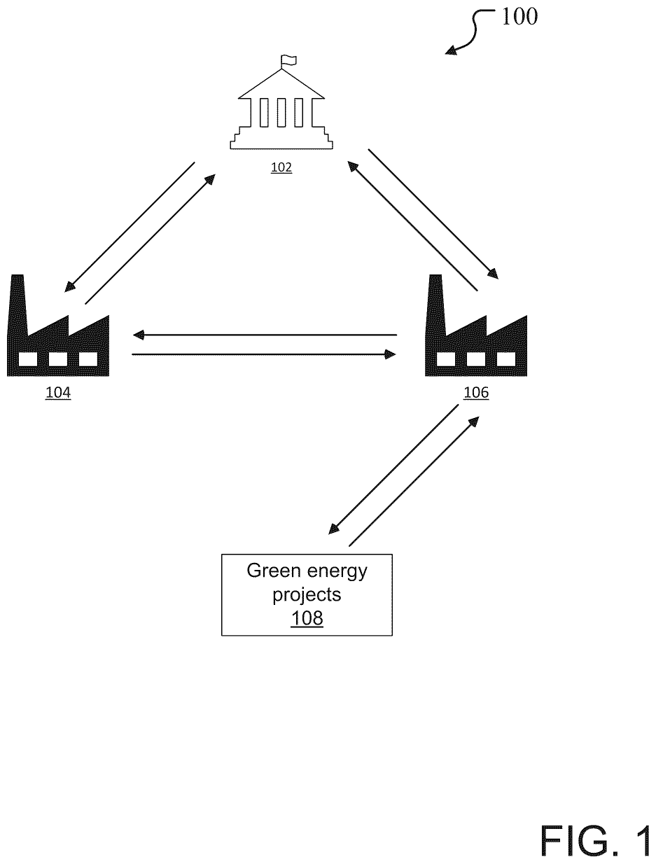

FIG. 1 shows a simplified schematic of a trading system according to Article 6.2 of the Paris Agreement. It should be understood that the Paris Agreement is not the only framework for CCT, and that other systems could be used now or created in future that would operate in a substantially similar manner.

As shown in FIG. 1, CCT system 100 includes a CCT administrator 102. CCT administrator 102 interacts with a first emitter 104 and a second emitter 106, as indicated by the arrows. Similarly, first emitter 104 and second emitter 106 can interact with one another. These interactions are described in more detail below.

Green projects 108 can also be included in a CCT system 100. In the embodiment shown in FIG. 1, green projects 108 can be connected to a single one of the emitters (in this case second emitter 106), though in other frameworks, green projects 108 can be connected to multiple emitters from a plurality of emitters, or can be connected to the CCT administrator 102 for handling of green credits or offsets.

As indicated by the arrows, CCT administrator 102 can allocate and distribute emissions credits to the first emitter 104 and the second emitter 106. As first emitter 104 and second emitter 106 emit greenhouse gases, they report emissions and surrender corresponding credits. CCT system 100 works on the concept that one of a plurality of emitters, such as first emitter 104, may emit less than its credit allowance. In such circumstances, first emitter 104 may sell additional emission credits to the second emitter 106.

Second emitter 106 may still require more allowance than it is allocated by the CCD administrator 102 or purchased from the first emitter 104. In such circumstances, green projects 108 can generate carbon offsets to sell to second emitter 106. Examples of green projects 108 include solar thermal power, offshore wind, green hydrogen, compressed biogas, emerging mobility solutions like fuel cells, tidal energy, and ocean thermal energy.

The system of FIG. 1 comports with Article 6.2 of the Paris Agreement, in which countries have the option to exchange carbon removals and reductions through cooperative agreements or initiatives, and in which emission-reduction projects are established in one country, allowing emitting entities in another country to offset their excess emissions by purchasing carbon credits. Emitters who have extra credits can sell them to other emitters, creating a carbon credits trading market.

FIG. 1 thus depicts transfers of ITMOs between CCT administrator 102, first emitter 104, second emitter 106, and green project 108. However, FIG. 1 does not address the problem of “corresponding adjustments” described above, in which adjustments are not applied to authorized carbon credits to prevent double counting. The system of FIG. 1 is a therefore an overly simple system, and its simplicity results in some of the weaknesses of the Paris Agreement described above.

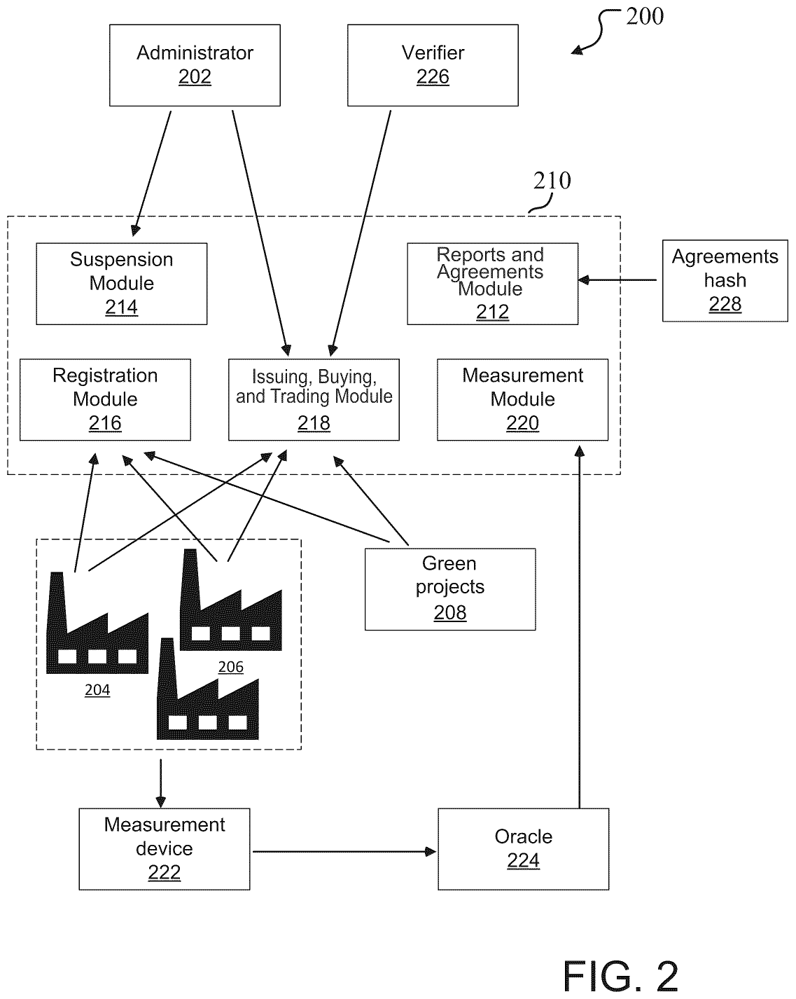

FIG. 2 shows a platform 200 for automation of carbon credits using smart contracts. Where similar actors, components, or elements are shown between different figures of this disclosure, those actors, components, or elements are depicted with reference numbers that vary from one another by multiples of 100. Thus, for example, platform 200 is similar to the CCT system 100 of FIG. 1, though platform 200 is a more sophisticated and detailed embodiment of a carbon credit trading environment. Where two components are similar to one another and share a reference number iterated by a multiple of 100, details of that element will not be repeated to avoid redundancy.

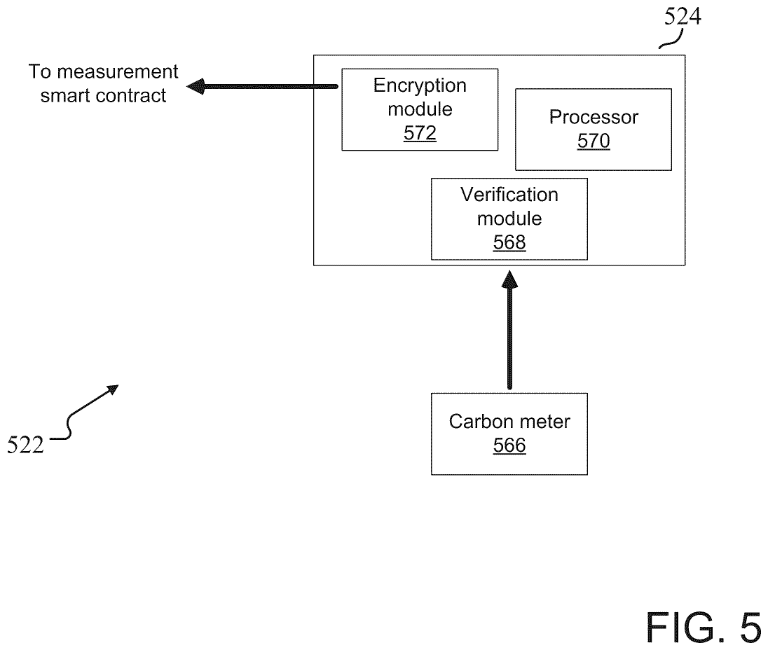

Platform 200 includes an administrator 202, and a plurality of emitters (depicted in the dashed lines, including at least two emitters shown as first emitter 204 and second emitter 206). Platform 200 also includes green projects 208. Each of these has been described above with respect to their counterparts in FIG. 1. Like FIG. 1, some arrows are shown to depict particular interactions between aspects of FIG. 2. However, it should be understood that not all of the possible interactions or relationships between components are depicted with an arrow. In general, it should be understood that each of the smart contracts may call any of a number of modules to perform certain functions, as described below with respect to FIG. 5, and that these modules may be called between any combination of different smart contracts. Furthermore, the emitters, green projects, administrators, and verifiers can all interact with any of the smart contracts, even though there may not be a specific arrow shown in FIG. 2.

Platform 200 includes blockchain network 210, depicted in dashed lines. Blockchain network, as described above, is a distributed computing network. Although depicted in FIG. 2 as a single component, it should be understood that blockchain network 210 and all the elements shown therein are not centralized and can be arranged throughout any number of computers, servers, IoT devices, or other networked devices.

Blockchain network 210 of platform 200 includes agreements module 212, suspension module 214, registration module 216, trading module, and measurement module 220.

Platform 200 includes measurement device 222. Measurement device 222 can be coupled to any of the plurality of emitters (e.g., first emitter 204 or second emitter 206). In embodiments, measurement device 222 can be a plurality of measurement devices, each corresponding to any of the plurality of emitters.

Measurement device 222 can provide measurement data to oracle 224 of platform 200. While measurement device 222 could, in an alternative embodiment, provide measurement data back to blockchain network 210 by directly communicating to the measurement module 220, the use of an oracle 224 provides various advantages. Oracle 224 can then provide measurement data for each of the plurality of measurement devices (e.g., measurement device 222) back to the measurement module 220 of the blockchain network 210.

Administrator 202 is also referred to herein as a creator. Administrators 202 (or creators 202) are responsible for creating and administering CCT schemes. A creator is an entity or organization that deploys the smart contracts to activate the blockchain-based CCT platform. The creator could be the (UNFCCC), the EU, a government establishing its national emission trading market, or any organization operating a CCT system. The creator of the smart contracts is the first administrator and is responsible for specifying the emitters' registration fees. Administrator 202 could be a general administrator or project independent verifier. General administrators 202, including the system creator, can authorize projects, issue carbon credits to green projects and suspend emitters or projects in case of violations. Independent verifiers on the other hand have one role. They verify green projects that were authorized by an administrator.

The plurality of emitters (e.g., first emitter 204 and second emitter 206) are the carbon-emitting entities participating in the platform. The plurality of emitters are obliged to pay a certain registration fee specified by the creator or administrator 202 to be able to join the platform 200 and perform buying and trading operations. The plurality of emitters can buy credits from green projects 208 or from others of the plurality of emitters who have excess credits from previous purchases from a project. The registration process in the blockchain-based CCT system depicted as platform 200 is automated and carried out by one or more smart contracts.

The green projects 208 support the CCT processes' implementation. Projects can go through a process of authorization and verification. Then, administrators issue a specific number of carbon credits for each green project 208. Carbon credits get sold to any of the plurality of emitters (e.g., first emitter 204 or second emitter 206) to help offset their emissions.

Each of the modules of the blockchain network 210 can operate via a smart contract. These can include, in one embodiment, a stakeholders registration smart contract, a participating countries' agreements and reports smart contract, a carbon credits issuing, buying, and trading smart contract, a suspension smart contract, and a measurement smart contract. Each of these smart contracts can be implemented via, for example, an Ethereum client or a front-end application, such that all participants in a smart contract who have distinct Ethereum Addresses (EAs) can communicate with the contract. This makes blockchain user-friendly since direct interaction with smart contracts requires a certain level of knowledge.

To begin the platform operations, one of the administrators 202, typically the creator, deploys the smart contracts sequentially. First the administrator 202 deploys the registration smart contract at the registration module 216. Registration module 216 adds other administrators 202 and verifiers 226.

Second, one or more administrator 202 deploys the agreements and reports smart contract at agreements module 212. Agreements module 212 can receive a plurality of parameters from the administrator 200, which can include a comprehensive database of all countries who signed the relevant agreement (e.g., the Paris Agreement) and want to participate in the blockchain CCT platform 200. These countries should upload their Paris Agreement copy, Nationally Determined Contribution (NDC) report, and CO2 inventory report via agreements hash 228. Agreements hash 228 can originate from a blockchain or other web3 storage system, such as the IPFS system in one embodiment.

As the web3 storage system creates a unique cryptographic agreements hash 228 key for each of these documents, countries insert those hashes into the smart contract. Failing to do so shall prevent emitters from the noncompliant jurisdiction from registering in the blockchain CCT platform 200 and buying or trading carbon credits. This database is used by verifiers 226 to verify and authenticate emitters' required commitments towards participating in the CCT platform 200.

Lastly, the administrator 202 deploys smart contracts for issuing, buying and trading smart contract and the suspension smart contract, at trading module 218 and suspension module 214, respectively.

Once all smart contracts are deployed and the CCT system is fully functional, green projects 208 can be added to the blockchain platform 210. The platform 200 requires several stages to register a green project 208. The blockchain network 210 records and announces the authorization of a new green project 208 once an administrator 202 inserts the project name, EA, country of origin, granted credit lot quantity, credit metric, credit purpose, and authorization methodology in one embodiment. Depending upon the framework, different requirements may be provided.

The green project 208 can then be reviewed off-chain by a registered independent verifier 226. The blockchain network 210 records and announces the verification process as the verifier inserts the project name, EA, country of origin, granted credit lot quantity, credit metric, credit purpose, and authorization methodology at the registration module 216. The green project 208 registration process is completed when the administrator 202 approves the decision of the verifier 226 and registers the project with the same parameters' value specified by the verifier 226.

The plurality of emitters (e.g., first emitter 204 and second emitter 206) also begin the registration to join the blockchain network 210 of the platform 200 and start interacting with the smart contracts described above. These processes are performed using the registration smart contract at the registration module 216. Also, as part of the requirements to join the platform, each of the plurality of emitters have to develop and deploy a blockchain-based emission measurement unit (EMU) which is a CO2 measuring smart contract fed by emissions reading data fetched by a CO2 meter or other device that can serve as a measurement device 222 for an amount of carbon measured by the measurement device 222. The EMU only allows administrators 202 to join the measurement smart contract at measurement module 220 for compliance and operation checks. At the registration module 216, emitters insert the EMU EA, pay the specified registration fees and provide their country name.

The blockchain network 210 of the platform 200 automatically validates and verifies that the emitter's country of origin had joined the CCT agreement (e.g., the Paris Agreement) and submitted its NDC and CO2 inventory reports. Any entity whose country did not sign the Paris Agreement and communicate the required reports will not be able to complete the registration process and consequently will not be allowed to join the platform even if it paid the registration fee. Our platform 200 binds each of the plurality of emitters (e.g., the first emitter 204 and the second emitter 206) to report its carbon inventory value which represents the emission sources quantified using standardized methods. This is a prerequisite for the plurality of emitters to be able to buy and trade carbon credits and is enabled via trading module 218 using the buying and trading smart contract.

The administrators 202 start issuing a plurality of allowances and/or credits to the plurality of emitters. This can include administrators 202 issuing carbon credits for projects by inserting the project name and EA into the issuing, buying and trading smart contract at trading module 218. In response, the platform 200 automatically creates a cryptographic ID for each credit lot. The total generated credit lot IDs for each project are equal to the credit lot quantity specified by the verifier 226. As the green projects 218 are, authorized, verified, and registered and the emitters are registered, paid their fees, and reported their carbon emissions, buying and trading processes become possible. Our developed platform 200 supports two roles for the plurality of emitters through its trading smart contract at trading module 218, either as buyers or sellers of carbon credits. Emitters taking the role of buyers to cover their excess emissions have two choices. Either they may buy credits from a registered green project 218 or from another registered emitter of the plurality of emitters (e.g., first emitter 204 or second emitter 206) that has surplus credits and takes the role of a seller. In any of those cases, the platform fetches the latest carbon credit price using an oracle. Once the trade operation satisfies the coded rules, Ethers or other currency equivalent to the price of the carbon credits get transferred from the buying emitter's account to the emission-reduction project's or the selling emitter's accounts in the blockchain. Also, carbon credit lots are transferred from the selling emitter or the project to the buying emitter. In case of any law violation by an emitter or emission-reduction project, the violating participant will be suspended and prevented from performing transactions. To implement this, the administrator 202 can call the suspension function in the suspension smart contract at the suspension module 214.

Platform 200 uses functions and algorithms to implement the systems processes and control stakeholders' interactions. The Ethereum address (EA), held by each stakeholder in the system, enables them to interact with the contract. Once the smart contracts get deployed, the system captures and saves the creator's Ethereum address (EA). A constructor, which is a special function used for initializing variables, adds the EA of the creator to be the first administrator 202 in the (adminList) map. The creator of the smart contract can add other administrators 202 to the system. Also, each added administrator 202 is capable of adding additional administrators 202. To add administrators 202, the function (addAdmin) is used which is restricted by the modifier (only Admin) and requires the administrator 202 EA as an input parameter. To add independent verifiers 226, the function (addVerifier) is used which is restricted by the modifier (onlyAdmin) and requires the verifier 226 EA as an input parameter. Algorithm 1 captures the initial deployment and administration stages taken by the creator or other administrators 202.

Algorithm 1: System Deployment and Administration

| | Input: SC creator EA, emitters registration fee |
|---|---|
| 1 | Insert creator or admin to admin list as a new admin |
| 2 | If new admin EA ≠ existing admin EA |
| 3 | Add new admin |
| 4 | else |
| 5 | Do not add admin and show an error. |
| 6 | Insert verifier to verifiers list |
| 7 | If new verifier EA ≠ existing verifier EA |
| 8 | Add new verifier |
| 9 | else |
| 10 | Do not add a verifier and show an error. |

Countries or other jurisdictions participating in the platform 200 use a smart contract at agreements module 212 to upload their Paris Agreement, NDC, and CO2 reports. Countries or jurisdictions can use the function (addParisAgreement) to insert the Paris Agreement hash and the joining date while they use (addCO2report) function to upload the CO2 report hash, for example. Also, countries use (addNDC) function to provide their NDC hash, title, language, translation, and version. Algorithm 2 demonstrates the document uploading process for participating countries.

Algorithm 2: System Regulation and
Agreement and Reports Uploading

| | Input: SC creator EA, registration smart contract EA | | |
|---|---|---|---|
| 1 | Insert Paris Agreement hash and joining date | | |
| 2 | If country EA ≠ existing country EA | | |
| 3 | \| | If country name ≠ existing country name | |
| 4 | \| | \| | If PA hash ≠ existing PA hash |
| 5 | \| | \| | Add PA hash & joining date to country record |
| 6 | \| | \| | Else |
| 7 | \| | \| | Do not add data and show error. |
| 8 | \| | Else | |
| 9 | \| | Do not add data and show error. | |
| 10 | Else | | |
| 11 | Do not add data and show error. | | |
| 12 | Insert CO₂ report hash | | |
| 13 | If country EA ≠ existing country EA | | |
| 14 | \| | If country name ≠ existing country name | |
| 15 | \| | \| | If CO₂ report hash ≠ existing CO₂ report hash |
| 16 | \| | \| | Add CO₂ report hash to country record |
| 17 | \| | \| | Else |
| 18 | \| | \| | Do not add data and show error. |
| 19 | \| | Else | |
| 20 | \| | Do not add data and show error. | |
| 21 | Else | | |
| 22 | Do not add data and show error. | | |
| 23 | Insert NDC hash, title, language, translation & version | | |
| 24 | If country EA ≠ existing country EA | | |
| 25 | \| | If country name ≠ existing country name | |
| 26 | \| | \| | If NDC hash ≠ existing NDC hash |
| 27 | \| | \| | Add NDC hash & information to country record |
| 28 | \| | \| | Else |
| 29 | \| | \| | Do not add data and show error. |

| | | |
|---|---|---|
| 30 | \| | Else |
| 31 | \| | Do not add data and show error. |

| | |
|---|---|
| 32 | Else |
| 33 | Do not add data and show error. |

Platform 200 enables tracking of green projects 208, including authorization, verification, and registration. Administrators 202 can use the function (authorizeNewProject) to authorize a new project by inserting its name, EA, country, authorization methodology, credits metric, purpose, and quantity. Platform 200 supports three authorization methodologies (M1, M2, M3), two credit metrics (CO2ton or KW), and two credit purposes (NDC or OIMP). The blockchain network 210 adds the green project 218 information to its data records and announces the authorization of a new project. Independent verifiers being part of the platform get notified via event listeners to start their off-chain verification process. Once a decision is made to verify the new project, the independent verifier uses the (verifyNewProject) function to update the project status by inserting the project name, EA, verification methodology, credit lot quantity, purpose, and metrics. Once a project is verified, its registration gets finalized by an admin using the function (regNewProject). Here the admin inserts the project name and EA while the parameters specified by the verifier are adopted in the (ProjectsInfo) map.

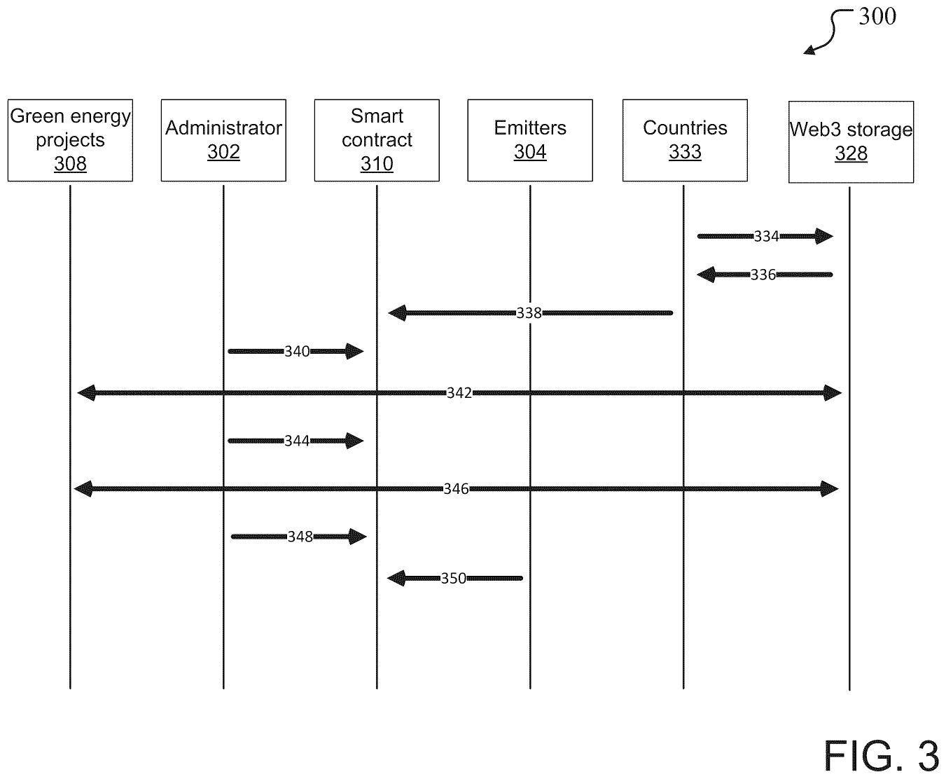

Registering green projects facilitates offsetting excess carbon emissions. Emitting entities can use the (regNewEmitter) payable function to register and pay the registration fees specified by the creator and insert three parameters: the emitter name, the country name, and EMU EA. The smart contract accesses the agreement and reports smart contract using its EA to validate that the emitter's country is part of the Paris Agreement and has submitted the required NDC and CO2 inventory reports. Once the country name is verified to exist in the countries' data records, the emitter is registered in the platform. The emitter gets mapped to its EA and added to the list of registered emitters (EmittersInfo) which includes all related emitter information. Algorithm 3 shows the registration process of emitters and projects. FIG. 3 shows the registration function messaging sequence. Using Algorithm 3, administrators 302 can issue credit lots (ITMOs) to registered emission reduction projects using the function (issueCredits).

Algorithm 3: Emitters and Emission-redaction
Projects Registration Process

| | Input: emitters name, country name, measurement SC | | | |
|---|---|---|---|---|
| | EA | | | |
| 1 | If msg.sender ≠ admin EA | | | |
| 2 | \| | If msg.sender EA ≠ existing emitter EA | | |
| 3 | \| | \| | If msg.value = registration fees | |
| 4 | \| | \| | \| | If country name exist in countries database |
| 5 | \| | \| | \| | register emitter & map new emitter |
| | \| | \| | \| | information to its EA |
| 6 | \| | \| | \| | Else |
| 7 | \| | \| | \| | Do not add emitter and show error. |

| 8 | \| | \| | Else |
|---|---|---|---|
| 9 | \| | \| | Do not add emitter and show error. |
| 10 | \| | Else | |
| 11 | \| | Do not add emitter and show error. | |
| 12 | Else | | |
| 13 | Do not add emitter and show error. | | |
| | Authorization Input: project name, project EA, | | |
| | country name, authorization methodology, credits | | |
| | metric, credits purpose, credit lots quantity. | | |
| 14 | If project EA ≠ admin EA | | |
| 15 | \| | If project EA ≠ emitter EA | |
| 16 | \| | \| | If project EA ≠ existing project EA |

| | | | |
|---|---|---|---|
| 17 | \| | \| | Authorize green project & map new project |
| | \| | \| | information to its EA |
| | \| | \| | Announce authorization of new project. |

| 18 | \| | \| | Else |
|---|---|---|---|
| 19 | \| | \| | Do not add project and show error. |
| 20 | \| | Else | |
| 21 | \| | Do not add project and show error. | |
| 22 | Else | | |
| 23 | Do not and project and show error | | |
| 24 | Verification Input: project name, project EA, | | |
| | authorization methodology, credits metric, credits | | |
| | propose, credit lots quantity. | | |
| 25 | If project EA ≠ admin EA | | |
| 26 | \| | If project EA ≠ emitter EA | |
| 27 | \| | \| | If project EA ≠ existing project EA |

| | | | |
|---|---|---|---|
| 28 | \| | \| | Authorize green project & map new project |
| | \| | \| | information to its EA |
| | \| | \| | Announce authorization of new project. |

| 29 | \| | \| | Else |
|---|---|---|---|
| 30 | \| | \| | Do not add project and show error. |
| 31 | \| | Else | |
| 32 | \| | Do not add project and show error. | |
| 33 | Else | | |
| 34 | Do not add project and show error | | |
| 35 | Registration Input: project name, project EA. | | |
| 36 | If project EA ≠ admin EA | | |
| 37 | \| | If project EA ≠ emitter EA | |
| 38 | \| | \| | If project EA ≠ existing project EA |

| | | | |
|---|---|---|---|
| 39 | \| | \| | Authorize green project & map new project |
| | \| | \| | information to its EA |
| | \| | \| | Announce authorization of new project. |

| | | | |
|---|---|---|---|
| 40 | \| | \| | Else |
| 41 | \| | \| | Do not add project and show error. |

| | | |
|---|---|---|
| 42 | \| | Else |
| 43 | \| | Do not add project and show error. |

| | |
|---|---|
| 44 | Else |
| 45 | Do not add project and show error. |

Administrators 202 are authorized to assign carbon credits to green projects 218. To assign credits for a registered project, project name and EA parameters can be used, in one embodiment. Then the issuing, trading and buying smart contract will loop over credit lots quantity approved by the verifier 226 and generate a unique cryptographic ID for each carbon credit lot by hashing a plurality of inputs, which can include credit lot number, project name, project EA, credits issuing country, issuing administrator EA, and transaction time. The smart contract at blockchain network 210 will generate a total quantity of credit lots equal to the quantity approved by the verifier 226. Also, the smart contract at the blockchain network 210 will calculate and save the validity of each credit, such as a duration, in the project information record. Furthermore, the smart contract at the blockchain network 210 will add the credit lots' cryptographic IDs to the total ITMOs data record. Algorithm 4 demonstrates the carbon credit issuing process. Emitters willing to buy carbon credits are obliged to report their emissions via (reportGHGinventory) function where each emitter inserts its name and emissions inventory.

Algorithm 4: Carbon credits issuing

| | Input: project name, project EA. | | | |
|---|---|---|---|---|
| 1 | If project EA ∈ registered projects data record | | | |
| 2 | \| | If project enable flag = true ( not suspended) | | |
| 3 | \| | \| | ▪ | Loop over approved credit lots qty & create |
| | \| | \| | | a cryptographic ID for each credit lot. |
| | \| | \| | ▪ | Set the validity for each carbon credit lot. |
| | \| | \| | ▪ | Add credit lots to project's information record. |
| | \| | \| | ▪ | Add credit lots to platform's ITMOs record. |

| | | |
|---|---|---|
| 4 | \| | Else |
| 5 | \| | Do not issue credits to green project. |

| | |
|---|---|
| 6 | Else |
| 7 | Do not issue credits to green project. |

An emitter of the plurality of emitters (e.g., first emitter 204 or second emitter 206) can buy carbon credits from a registered emission-reduction project to cover its excess emissions by calling the function (buyProjectCredits). The smart contract at the blockchain network 210 restricts calling this function to emitters with valid registration who provided their emission inventory. The buying entity has to insert a set of parameters, which can include: emitter name, project name, project EA, purchased credit lot qty, credit lot unit value, and credit purpose. Certain coded conditions have to be fulfilled before buying carbon credits which are: (a) only registered emitters of the plurality of emitters can participate in the trading process as a buyer; only registered emission-reduction projects can participate in the trading process; (c) the buying and selling entities are not suspended and their registration is still valid. Other conditions can be added depending upon the specific CCT system requirements.

The Ethers or other currency value paid by the buying emitter should equal the quantity of credit lots multiplied by the unit price. The quantity of credit lots requested by the buying emitter of the plurality of emitters should be less than or equal to the quantity of credit lots available in the project's balance. Once all buying requirements are met, carbon credit balances get updated for both the buying emitter and the green project and so do the Ether balances. The smart contract generates a unique ID for the transaction and maps the transaction to its (TxID) in the (TX_ITMO_Detail) map. Algorithm 5 demonstrates the logic behind the carbon credit buying process.

Algorithm 5: Carbon Credits Buying

| | Input: emitter name, project name, project EA, | | | | | | |
|---|---|---|---|---|---|---|---|
| | purchased credit lots qty, credit lots unit value, | | | | | | |
| | credit purpose. | | | | | | |
| 1 | If project EA ∈ projects list | | | | | | |
| 2 | \| | If emitter EA ∈ emitters list | | | | | |
| 3 | \| | \| | If msg.value = credit lot qty * units value | | | | |
| 4 | \| | \| | \| | If emitter validity = true | | | |
| 5 | \| | \| | \| | \| | If project validity = true | | |
| 6 | \| | \| | \| | \| | \| | ▪ | transfer credits from project to |
| | \| | \| | \| | \| | \| | | emitter |
| | \| | \| | \| | \| | \| | ▪ | update Ethers & credits |
| | \| | \| | \| | \| | \| | | balances for project and emitter |
| | \| | \| | \| | \| | \| | ▪ | Create TX ID. |
| | \| | \| | \| | \| | \| | ▪ | Update ITMOs data record with |

| | | | | | |
|---|---|---|---|---|---|
| \| | \| | \| | \| | \| | the new TX ID. |

| | | | | | |
|---|---|---|---|---|---|
| 7 | \| | \| | \| | \| | Else |
| 8 | \| | \| | \| | \| | Do not trade offset permits and show |

| | \|error | | \| | |
|---|---|---|---|---|
| 9 | \| | \| | \| | Else |

| | | | |
|---|---|---|---|
| 10 | \| | \| | Do not trade credits and show error. |

| | | | |
|---|---|---|---|
| 11 | \| | \| | Else |

| | | |
|---|---|---|
| 12 | \| | Do not trade credits and show error. |

| | | |
|---|---|---|
| 13 | \| | Else |

| | |
|---|---|
| 14 | Do not trade credits and show error. |

| | |
|---|---|
| 15 | Else |
| 16 | Do not trade credits and show an error. |

Any registered emitter of the plurality of emitters can put part of the carbon emission credits assigned to it for sell by calling the function (putUnitsForSell). Intended sellers have to insert parameters, such as: selling emitter name and number of credit lots for sell. In one embodiment, two conditions have to be met for the emitter to put credit units for sell which are: the emitter is not suspended, its registration status is still active and the quantity of intended credit lots for sell does not exceed the quantity of credit lots in seller's possession. Once all requirements are fulfilled, the credits are put for sell and their quantity, seller name, and seller EA are mapped to the (sellingEmitter) list. Also, an event is emitted to announce putting credits for sale. Algorithm 6 demonstrates how credits are put for sale.

Algorithm 6: Carbon Credits Sell Offer

| | Input: Seller name, credit lots qty for sell. | | | | |
|---|---|---|---|---|---|
| 1 | If qty of credit lots for sell <= qty of credit lots in | | | | |
| | seller balance | | | | |
| 2 | \| | If seller EA ∈ emitters list | | | |
| 3 | \| | \| | If seller validity = true | | |
| 4 | \| | \| | \| | ▪ | Put the specified credit lots qty for |

| | | | |
|---|---|---|---|
| \| | \| | \| | sell. |

| | | | |
|---|---|---|---|
| \| | \| | ▪ | Announce credits for sell. |

| | | | |
|---|---|---|---|
| 5 | \| | \| | Else |

| | | |
|---|---|---|
| 6 | \| | Do not put credits for sell and show error. |

| | | |
|---|---|---|
| 7 | \| | Else |

| | |
|---|---|
| 8 | Do not put credits for sell and show error. |

| | |
|---|---|
| 9 | Else |
| 10 | Do not put credits for sell and show an error. |

The carbon credits trading, using trading module 218, takes place between two registered emitters of the plurality of emitters (e.g., between first emitter 204 and second emitter 206) where one of them only is a seller who has already put some credits for sale. The buying emitter performs the trading by calling the function (buyEmittersCredits) which requires that both emitters have valid registration.

The buying emitter should insert parameters sufficient to complete the transaction, such as: receiving emitter name, transferring emitter name, transferring emitter address, purchased credit lots qty, and credit lot unit value. In this stage, the buying entity will be utilizing the service of a trusted blockchain oracle to obtain the price of carbon credits from the stock market. The suitable oracle can be an inbound publish-subscribe type. The inbound oracle can transfer authenticated data to the smart contract opposite to the outbound oracle. The publish-subscribe or feed-type oracle can be updated once the fetched data changes and notifies users that newer information is available. Different oracle platforms exist in the blockchain sector such as Provable and Chainlink. Certain conditions have to be fulfilled before the trading of credits successfully occurs. In one embodiment, these coded terms are: Only registered emitters can participate in trading, the Ethers value should equal the number of credit lots multiplied by the unit price fetched by an oracle, the selling entity had put credits for sell and is listed on the sellers' map, the buying and selling entities are not suspended, and their registrations are still valid, and the traded credit lots quantity does not exceed the credit lots put for sell by the seller.

Once all trading requirements are met, credit balances get updated for both buyer and seller and so do the Ether balances. The smart contract generates a unique ID for the transaction and maps the transaction to its (TxID) in the (TX_ITMO_Detail) map. Algorithm 7 shows the carbon credits trading process between two emitters.

Algorithm 7: Carbon Credits Trading

| | Input: receiving emitter name, transferring emitter | | | | | | | |
|---|---|---|---|---|---|---|---|---|
| | name, transferring emitter address, purchased credit | | | | | | | |
| | lots qty, and credit lot unit value. | | | | | | | |
| 1 | If msg.sender ∉ sellers list | | | | | | | |
| 2 | \| | If seller EA ∈ sellers list | | | | | | |
| 3 | \| | \| | If traded credit lots qty < qty of credit lots for sell | | | | | |
| 4 | \| | \| | \| | If msg.value = traded qty * unit value | | | | |
| 5 | \| | \| | \| | \| | If seller validity = true | | | |
| 6 | \| | \| | \| | \| | \| | If buyer validity = true | | |
| 7 | \| | \| | \| | \| | \| | \| | ▪ | transfer credits to buyer. |
| | \| | \| | \| | \| | \| | \| | ▪ | update Ethers & credits balances |
| | \| | \| | \| | \| | \| | \| | | for buyer and seller. |
| | \| | \| | \| | \| | \| | \| | ▪ | Create TX ID. |
| | \| | \| | \| | \| | \| | \| | ▪ | Update ITMOs data record with |

| | | | | | | |
|---|---|---|---|---|---|---|
| \| | \| | \| | \| | \| | \| | the new TX ID. |

| | | | | | | |
|---|---|---|---|---|---|---|
| 8 | \| | \| | \| | \| | \| | Else |
| 9 | \| | \| | \| | \| | \| | Do not trade credits and show error. |
| 10 | \| | \| | \| | \| | \| | Else |
| 11 | \| | \| | \| | \| | \| | Do not trade credits and show error. |

| | | | | | |
|---|---|---|---|---|---|
| 12 | \| | \| | \| | \| | Else |
| 13 | \| | \| | \| | \| | Do not trade credits and show an error. |

| | | | | |
|---|---|---|---|---|
| 14 | \| | \| | \| | Else |
| 15 | \| | \| | \| | Do not trade credits and show an error. |

| | | | |
|---|---|---|---|
| 16 | \| | \| | Else |
| 17 | \| | \| | Do not trade credits and show an error. |

| | | |
|---|---|---|
| 18 | \| | Else |
| 19 | \| | Do not trade credits and show an error. |

| | |
|---|---|
| 20 | Else |
| 21 | Do not trade credits and show an error. |

The platform 200 can also facilitate suspending any of the plurality of emitters or and green project 218 that violates the rules. To suspend a user, an administrator 202 can call the function (suspParty) which is restricted by the modifier (onlyAdmin) and insert the suspended party address as a parameter. Algorithm 8 demonstrates the suspension processes.

Algorithm S: Suspend Party

| | Input: suspended party EA. |
|---|---|
| 1 | Disable party registration |
| 2 | Remove emitter from seller list |
| 3 | Set the party's validity flag to false |

As the platform 200 binds each of the plurality of emitters (e.g., first emitter 204 and second emitter 206) to develop an EMU, measuring devices 222 should be mounted on specific positions in emitters' premises such as manufacturing plants and other facilities to capture the amount of CO2 emissions. A cryptographically secure Emission Measurement Unit (EMU) is a smart contract based system built using the Ethereum blockchain and linked to a measurement device 222. It can include a carbon meter (or meter for other greenhouse gases or climate change agents), which records the amount of an emission or amount of the climate change agent in the area. The measurement device 222 can further include a microcontroller or similar device to provide the required processing power and communication ability, as such acting as the fundamental component of the EMU. The measurement device 222 can be programmed to produce a reading at specific time intervals.

The measurement device 222 can use asymmetric key algorithm (AKA) or other encoding as part of its cryptographic scheme. AKA is well known for its security since it ensures that messages get signed by the device's private key, verifying the sender's identity and protecting the fetched data from tampering or manipulation. Using a private key that is integrated into the hardware of the device creates a tamper-proof system and a secure environment that protects the identity of the measurement device 222 and its readings making it extremely resistant to manipulation attempts and forming what is known as a hardware oracle 224.

The microprocessor or other processing componentry of the measurement device 222 can fetch the emissions values at certain times triggered by the timer and cryptographically attest them using the meter's private key through the AKA or other encryption mechanism. The resulting cryptographic reading is inserted into the smart contract at measurement module 220. The measurement smart contract at measurement module 220 can specify the threshold value at deployment of the measurement device 222 via a constructor. The function (CarbonData) captures the following parameters: carbon data, meter ID and reading time, for an embodiment in which the measurement device 222 is a carbon emission reader. CarbonData records all readings associated with each sensor ID in (CO2readings) map. It also compares each and every reading for each sensor to a threshold and triggers a warning in case of exceeding that threshold. The smart contract keeps records of all violations in (CO2violations) map. One example of such a device is described in more detail below with respect to FIG. 5.

FIG. 3 is a flowchart showing one example of communications used in the registration module 216, implemented as registration functions message method 300. Registration functions message method 300 graphically depicts communications between an administrator 302, a plurality of emitters 304, green projects 308, smart contract 310, web3 storage 328, and authorities 332.

At 334, countries 333 upload agreements and reports to web3 storage 328. Web3 storage saves these details and returns a documents hash at 336. At 338, countries upload Paris Agreement (or other agreement) has information and any other required information to smart contract 310. For example, this could use the addParisAgreement( ) function of Algorithm 2. At 340, a creator or other administrator 302 adds details needed to authorize a new project, for example using the authorizeNewProject( ) function described above. Smart contract 310 can add the project to ProjectsInfo mapping and flag the project as authorized.

At 342, the newly authorized project from 340 is emitted to all users of the blockchain network e.g., blockchain network 210 of FIG. 2.

At 344, the administrator 302 or a verifier (e.g., verifier 226 of FIG. 2) can verify the project details, such as using the verifyNewProject( ) function described above. Assuming the details are correct, the project can then be flagged as verified.

At 346, the newly verified project from 338 is emitted to all users of the blockchain network.

At 348, the administrator 302 or a verifier (e.g., verifier 226 of FIG. 2) can register the project. After it is registered, emitters 304 can access the project and pay registration fees via a regNewEmitter( ) function. The emitters 304 that do so can be added to an EmittersInfo map.

This simplified sequence can include a variety of other steps or interactions with other users of the blockchain network.

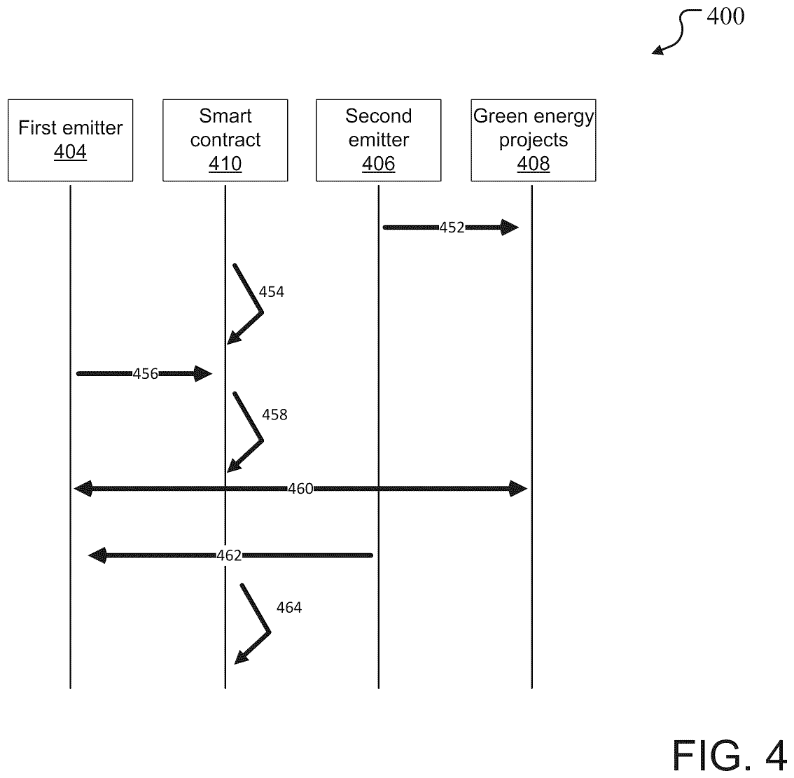

The carbon credits buying and trading processes message sequencing of the trading module 218 of FIG. 2 are shown in FIG. 4.

At 452, buying emitter, second emitter 406, transmits information necessary to call a function, buyProjectCredits( ) from a green project 408. Smart contract 410 then updates credits and currency balances at 454, and makes the updated information available on the blockchain network.

At 456, a selling emitter, first emitter 404, provides a seller name and quantity of credits available to sell via the smart contract 410. Smart contract 410 may add first emitter 404 to a selling emitter listing. As shown at 460, addition of the first emitter 404 to the selling emitter listing may result in an announcement to all users of the blockchain network that there are credits for sale, with some details.

In response to the indication at 460 that there are credits available for sale, the buying emitter, second emitter 406, may use the buyEmittersCredits( ) function to purchase credits from the selling emitter, first emitter 404. In that event, smart contract 410 updates credits and balances, both of currency and of carbon credits.

Similar function calls and events can be used to carry out various functionality described above with respect to the agreements module 212, the suspension module 214, the registration module 216, the trading module 218, and the measurement module 220. The details of these modules can be found in the following table.

One example developed solution consists of eight modules working together to form a blockchain platform for carbon credits trading (CCT) that fulfills Paris Agreement (Article 6). Our system utilizes the key features of blockchain technology, smart contracts distinguished characteristics, distributed peer-to-peer InterPlanetary File System (IPFS), Internet of Things paradigm, and trusted hardware oracles gateways to develop a carbon credits trading (CCT) system. Our blockchain platform consists of a nest of smart contracts linked together where participants interact using the following modules and units to create a complete functional platform:

| Module: | Description/Breakdown | |
|---|---|---|
| Module 1: | Unit 1 | Database for Paris Agreement |
| Comprehensive | | certificates hash. |
| Database | Unit 2 | Database for Nationally Determined |
| | | Contributions (NDC) reports. |
| | Unit 3 | Database for carbon inventory reports. |
| Module 2: | Unit 1 | Administrators registration. |
| Registration | Unit 2 | Green projects registration. |
| System | Unit 3 | Emitters registration. |
| Module 3: | Unit 1 | Green projects carbon credits issuing and |
| Issuance System | | cryptographic ID generation. |
| Module 4: CO₂ | Unit 1 | Emitters CO₂ inventory value reporting. |
| Inventory System | | |
| Module 5: | Unit 1 | Peer-to-peer, secure green projects carbon |
| Carbon Credits | | credits purchasing functionality. |
| Purchasing | Unit 2 | Automatic payment facility using Ether. |
| System | Unit 3 | Traceable and transparent credits |
| | | transactions database. |
| | Unit 4 | Carbon management and balance |
| | | calculation. |
| Module 6: | Unit 1 | Peer-to-peer and secure carbon credits |
| Carbon Credits | | trading between emitters. |
| Trading System | Unit 2 | Automatic payment facility using Ether. |
| | Unit 3 | Traceable and transparent credits |
| | | transactions database. |
| | Unit 4 | Carbon management and balance |
| | | calculation. |
| Module 7: | Unit 1 | Suspension system for projects registration |
| Suspension | | in case of rules violation. |
| System | Unit 2 | Suspension system for emitters' registration |
| | | in case of rules violation. |
| Module 8: | Unit 1 | Measurement and monitoring of CO₂ |
| Carbon | | emissions released by emitter. |
| Measurement | Unit 2 | Traceable carbon emissions values |
| System | | database. |
| | Unit 3 | 2-levels warning system for emissions |
| | | exceeding risk zone and/or violation zone |

The result is a decentralized, trusted, secure, reliable, immutable, auditable, transparent, traceable robust automated carbon credits trading system with reduced execution time and cost.

FIG. 5 shows a measurement device 522, similar to the measurement device 222 of FIG. 2. The measurement device 522 of FIG. 5 is a carbon measurement device, though as described above it may be desirable in some other contexts to measure other greenhouse gas emissions, such as methane or certain refrigerants that also contribute to global warming.

In the embodiment shown in FIG. 5, however, measurement device 522 includes a carbon meter 566 that sends a signal to an oracle 524. The signal sent from the measurement device 522 can be encrypted, such as with a private key.

Oracle 524 is capable of decrypting the signal from the carbon meter 566 and sending encrypted carbon readings to the smart contract of a measurement module in a blockchain network, as described with respect to FIG. 2. To accomplish this, oracle 524 may include a verification module 568 and a processor 570 for decrypting the signal from the carbon meter 566. The processor 570 can use a separate encryption module 572 to encrypt and send the signal to the smart contract.

The disclosed systems and methods provide a groundbreaking blockchain-based platform for carbon credits trading. This platform not only facilitates the trading of carbon credits but also includes complementary operations such as registration, issuance, and suspension, forming a comprehensive and efficient system. These systems and methods take into account the challenges faced by the current carbon credits trading market and incorporate insights from existing carbon trading frameworks. By identifying the environmental needs, efficiency requirements, and gaps in existing frameworks, as well as leveraging the capabilities of blockchain technology and the Internet of Things (IoT), we have developed a novel and inventive solution.

One feature of the platform that provides outsized advantage over conventional approaches is the integration of sensors into the blockchain, adopting the concept of a blockchain of things. This allows for the supply of reliable and secure information to all participants in the carbon credits trading market. It also provides a crucial monitoring, tracking, and measurement tool for CO2 emissions. Additionally, platform described herein offers an automated registration process through smart contracts, saving time, enhancing efficiency, and reducing errors. The issuance and management of CO2 credits are also handled by smart contracts, ensuring the correct flow of the issuing process and maintaining transparency and traceability in credit and currency transfers.

Furthermore, the systems and methods described herein address the challenges of fragmented markets by enabling a unified carbon trading market. It eliminates variations in regulations, unifies the price of carbon permits, and reduces the consequences of dispersed markets. The platform operates with reduced time and increased efficiency, saving on banking system resources and minimizing potential errors. Through the implementation of a nest of smart contracts and rigorous testing, we have ensured the robustness and security of our platform.

The blockchain-based platform described herein thus offers an ideal and comprehensive solution for optimizing the carbon credits trading scheme, addressing its challenges, and effectively tackling the climate change phenomenon. Features such as the integration of sensors and automated smart contracts set it apart from existing frameworks and pave the way for a more transparent, efficient, and secure carbon credits trading market.

This disclosure described some examples of the present technology with reference to the accompanying drawings, in which only some of the possible examples were shown. Other aspects can, however, be embodied in many different forms and should not be construed as limited to the examples set forth herein. Rather, these examples were provided so that this disclosure was thorough and complete and fully conveyed the scope of the possible examples to those skilled in the art.

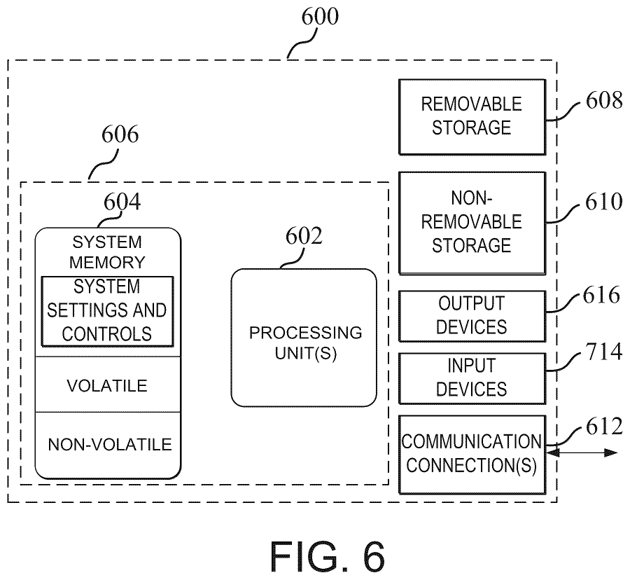

FIG. 6 depicts one example of a suitable operating environment 600 in which one or more of the present examples can be implemented. This operating environment may be incorporated directly into the controller for a carbon emission measurement device, for example, or a computing device such as a server on which any of the smart contracts is implemented. This is only one example of a suitable operating environment and is not intended to suggest any limitation as to the scope of use or functionality. Other well-known computing systems, environments, and/or configurations that can be suitable for use include, but are not limited to, personal computers, server computers, hand-held or laptop devices, multiprocessor systems, microprocessor-based systems, programmable consumer electronics such as smart phones, network PCs, minicomputers, mainframe computers, tablets, distributed computing environments that include any of the above systems or devices, and the like.

In its most basic configuration, operating environment 600 typically includes at least one processing unit 602 and memory 604. Depending on the exact configuration and type of computing device, memory 604 (storing, among other things, instructions to control the eject the samples, move the stage, or perform other methods disclosed herein) can be volatile (such as RAM), non-volatile (such as ROM, flash memory, etc.), or some combination of the two. This most basic configuration is illustrated in FIG. 6 by dashed line 606. Further, environment 600 can also include storage devices (removable, 608, and/or non-removable, 610) including, but not limited to, magnetic or optical disks or tape. Similarly, environment 600 can also have input device(s) 614 such as touch screens, keyboard, mouse, pen, voice input, etc., and/or output device(s) 616 such as a display, speakers, printer, etc. Also included in the environment can be one or more communication connections 612, such as LAN, WAN, point to point, Bluetooth, RF, etc.

Operating environment 600 typically includes at least some form of computer readable media. Computer readable media can be any available media that can be accessed by processing unit 602 or other devices having the operating environment. By way of example, and not limitation, computer readable media can include computer storage media and communication media. Computer storage media includes volatile and nonvolatile, removable and non-removable media implemented in any method or technology for storage of information such as computer readable instructions, data structures, program modules or other data. Computer storage media includes, RAM, ROM, EEPROM, flash memory or other memory technology, CD-ROM, digital versatile disks (DVD) or other optical storage, magnetic cassettes, magnetic tape, magnetic disk storage or other magnetic storage devices, solid state storage, or any other tangible medium which can be used to store the desired information. Communication media embodies computer readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media. A computer-readable device is a hardware device incorporating computer storage media.

The operating environment 600 can be a single computer operating in a networked environment using logical connections to one or more remote computers. The remote computer can be a personal computer, a server, a router, a network PC, a peer device or other common network node, and typically includes many or all of the elements described above as well as others not so mentioned. The logical connections can include any method supported by available communications media. Such networking environments are commonplace in offices, enterprise-wide computer networks, intranets and the Internet.

In some examples, the components described herein include such modules or instructions executable by computer system 600 that can be stored on computer storage medium and other tangible mediums and transmitted in communication media. Computer storage media includes volatile and non-volatile, removable and non-removable media implemented in any method or technology for storage of information such as computer readable instructions, data structures, program modules, or other data. Combinations of any of the above should also be included within the scope of readable media. In some examples, computer system 600 is part of a network that stores data in remote storage media for use by the computer system 600.

Although specific examples were described herein, the scope of the technology is not limited to those specific examples. One skilled in the art will recognize other examples or improvements that are within the scope of the present technology. Therefore, the specific structure, acts, or media are disclosed only as illustrative examples. Examples according to the technology may also combine elements or components of those that are disclosed in general but not expressly exemplified in combination, unless otherwise stated herein. The scope of the technology is defined by the following claims and any equivalents therein.

What is claimed is:

1. A platform for automation of carbon credits using smart contracts, the platform comprising:
an agreements module configured to receive a plurality of parameters from an administrator to assign a plurality of credits to a corresponding plurality of emitters using an assignment transaction to be included in a transaction block in a cryptographically verifiable ledger;
a suspension module configured to selectively suspend any of the plurality of emitters by generating a suspension transaction to be included in a transaction block in the cryptographically verifiable ledger;
a registration module configured to register the plurality of emitters using a plurality of registration transactions to be included in a transaction block in the cryptographically verifiable ledger;
a trading module configured to generate a plurality of trading transactions to be included in a transaction block on the cryptographically verifiable ledger, each of the plurality of trading transactions corresponding to a purchase or sale of carbon credits as between the plurality of emitters;
a measurement module, wherein the measurement module is private and exclusive to the administrator and to an emitter of the plurality of emitters that generated emissions measured by the measurement module, wherein the measurement module is communicatively coupled to a plurality of measurement devices arranged amongst the plurality of emitters, and wherein the plurality of measurement devices are configured to automatically report carbon generation, such that the measurement module generates a measurement transaction corresponding to an amount of carbon measured by the plurality of measurement devices to be stored on the cryptographically verifiable ledger based upon a level of emissions output by the plurality of emitters.

2. The platform for automation of carbon credits using smart contracts of claim 1, wherein each of the agreements module, the suspension module, the registration module, the trading module, and the carbon measurement module are configured to create smart contracts that generate transaction blocks on the cryptographically verifiable ledger.

3. The platform for automation of carbon credits using smart contracts of claim 1, wherein the administrator is further configured to assign a plurality of credits to one or more green projects, and:
the suspension module is further configured to selectively suspend any of the one or more green projects by generating a suspension transaction to be included in a transaction block in the cryptographically verifiable ledger;
the registration module is further configured to register the one or more green projects using a plurality of registration transactions to be included in a transaction block in the cryptographically verifiable ledger; and
the plurality of trading transactions to be included in a transaction block in the cryptographically verifiable ledger correspond to a purchase or sale of carbon credits including the one or more green projects.

4. The platform for automation of carbon credits using smart contracts of claim 1, further comprising the plurality of measurement devices arranged at the plurality of emitters to provide carbon emission measurement data to the measurement module.

5. The platform for automation of carbon credits using smart contracts of claim 4, further comprising a blockchain oracle communicatively coupled to the plurality of measurement devices and the measurement module.

6. The platform for automation of carbon credits using smart contracts of claim 1, wherein the agreements module is communicatively coupled to web3 storage to receive an agreements hash therefrom.

7. The platform for automation of carbon credits using smart contracts of claim 1, wherein the trading module is configured to implement smart contracts that trade carbon credits with the plurality of emitters.

8. The platform for automation of carbon credits using smart contracts of claim 1, wherein the registration module is configured to register the plurality of emitters.

9. A set of smart contracts implemented in a blockchain-based carbon trading system, the set of smart contracts comprising:
a registration smart contract configured to:
register a plurality of emitting entities;
receive registration fees from the plurality of emitting entities;
store the plurality of emitting entities in a cryptographically verifiable ledger; and
map emitters to their corresponding identifiers upon successful registration;
an agreements smart contract configured to:
receive international agreement details; and
insert document hashes into the international agreement details;
a trading smart contract configured to:
facilitate the purchase and sale of carbon credits between the plurality of emitting entities;
record transactions related to carbon credits in the cryptographically verifiable ledger; and
dynamically update ownership of the carbon credits based on the transactions recorded to the cryptographically verifiable ledger;
a suspension smart contract configured to:
selectively suspend the plurality of emitting entities based on violations or non-compliance;
generate and record suspension transactions in a transaction block on the cryptographically verifiable ledger; and
update the status of the plurality of the plurality of emitting entities and projects accordingly;
a measurement smart contract configured to:
interface with a plurality of measurement devices among the plurality of emitting entities;
receive and record carbon generation data automatically reported by the plurality of measurement devices;
generate carbon measurement transactions based on an actual emission output, storing the carbon measurement transactions on the cryptographically verifiable ledger; and
ensure the measurement module remains private and exclusive to administrators and the plurality of emitting entities;
wherein the set of smart contracts are configured to collectively automate the processes of stakeholder registration, agreement and report management, carbon credit issuance and trading, suspension enforcement, and carbon output measurement within the carbon trading system.

10. The set of smart contracts implemented in the blockchain-based carbon trading system of claim 9, wherein:
the registration smart contract is further configured to receive registration fees from a plurality of emission-reduction projects, store project information corresponding to the plurality of emission-reduction projects in the cryptographically verifiable ledger, and map the plurality of emission-reduction projects to their corresponding identifiers upon successful registration;
the agreements smart contract is further configured to authorize, issue, and assign carbon credits to emission-reduction projects based on predefined criteria, facilitate purchase and sale of carbon credits between the plurality of emitting entities and the plurality of emission-reduction projects; and
the suspension smart contract is further configured to selectively suspend the plurality of emission-reduction projects based on violations or non-compliance.

11. The set of smart contracts implemented in the blockchain-based carbon trading system of claim 9, wherein the measurement smart contract is configured to receive encrypted measurement data from each of the plurality of measurement devices.

12. The set of smart contracts implemented in the blockchain-based carbon trading system of claim 9, further comprising a blockchain oracle communicatively coupled to the plurality of measurement devices and the measurement smart contract.

13. The set of smart contracts implemented in the blockchain-based carbon trading system of claim 9, wherein the agreements smart contract is configured to receive a hash from a web3 storage.

14. A method for automating carbon credits using a blockchain-based platform, the method comprising:
receiving a plurality of parameters from an administrator to assign a plurality of credits to a corresponding plurality of emitters using an assignment transaction;
recording the assignment transaction in a transaction block in a cryptographically verifiable ledger;
registering the plurality of emitters, by a registration module, with a plurality of registration transactions recorded in a transaction block in the cryptographically verifiable ledger;
generating a plurality of trading transactions and recording each of the plurality of trading transactions on the cryptographically verifiable ledger, each of the plurality of trading transactions corresponding to a purchase or sale of carbon credits as between the plurality of emitters;
generating a plurality of measurement transactions by a measurement module, wherein the measurement module is private and exclusive to the administrator and to an emitter of the plurality of emitters that generated emissions measured by the measurement module, wherein the measurement module is communicatively coupled to a plurality of measurement devices arranged amongst the plurality of emitters, and wherein the plurality of measurement devices are configured to automatically report carbon generation, such that the measurement module generates the plurality of measurement transactions corresponding to an amount of carbon measured by the plurality of measurement device to be stored on the cryptographically verifiable ledger based upon actual carbon output by the plurality of emitters.

15. The method for automating carbon credits using a blockchain-based platform of claim 14, further comprising creating a suspension transaction to be included in a transaction block in the cryptographically verifiable ledger by a suspension module configured to selectively suspend any of the plurality of emitters.

16. The method for automating carbon credits using a blockchain-based platform of claim 14, further comprising receiving a plurality of parameters from the administrator to assign a plurality of allowances to a corresponding plurality of green projects.

17. The method for automating carbon credits using a blockchain-based platform of claim 16, wherein the plurality of trading transactions include a purchase or sale of carbon allowances including at least one of the plurality of green projects.

18. The method for automating carbon credits using a blockchain-based platform of claim 16, wherein the plurality of measurement transactions include measurements from the plurality of green projects.
